(19) United States
(12) Patent Application Publication
(10) Pub. No.: US 2020/0072779 A1
(43) Pub. Date: Mar. 5, 2020

(54) CONDUCTIVE SHIELD, SCRATCH DETECTING APPARATUS AND METHOD BASED ON THE CONDUCTIVE SHIELD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YAN-QIANG YE, Shenzhen (CN); REN-WEN HUANG, Shenzhen (CN); JUN ZHANG, Shenzhen (CN)

(21) Appl. No.: 16/248,990

(22) Filed: Jan. 16, 2019

(30) Foreign Application Priority Data
Aug. 31, 2018 (CN) 201811014158.9

(51) Int. Cl. G01N 27/24; B60R 16/023

(52) U.S. Cl. CPC G01N 27/24; B60R 16/023

(57) ABSTRACT

A two-part conductive shield for an object or vehicle likely to suffer surface damage includes a first film on an outer surface of the vehicle, and a second film on an inner surface of the vehicle. The films may be applied as coatings. Capacitance of the conductive shield can be measured for reference and for in-use purposes, thus determining whether there is a change in an area of the first film opposite to the second film can indicate a scratch or other surface damage, and an instant warning or prompt given. A scratch detecting apparatus and a scratch detecting method are also provided.

### FIELD

The disclosure generally relates to a conductive shield, a scratch detecting apparatus and a method based on the conductive shield.

### BACKGROUND

Fault indicator lights can indicate an internal fault in a vehicle, but surface scratches or indentations on a body of the vehicle needs to be checked by visual inspections. Users may not walk around the car to check whether the car is scratched before boarding the car, hence scratches or bumps may be discovered several days after the scratches or bumps are inflicted on the car. Therefore, the user may not receive an immediate indications of a scratch or a bump on the car.

### BRIEF DESCRIPTION OF THE DRAWINGS

Implementations of the present technology will now be described, by way of embodiments, with reference to the attached figures.

FIG. 1 is a block diagram illustrating an embodiment of a scratch detecting apparatus.

FIG. 2 is an isometric view of an embodiment of a conductive shield.

FIG. 3 is a block diagram illustrating an embodiment of a scratch detecting system.

FIG. 4 is a flowchart illustrating an embodiment of a scratch detecting method.

FIG. 5 is a schematic diagram illustrating an embodiment of a display interface on an output unit.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”, it specifically indicates open-ended inclusion or membership in a so-described combination, group, series, and the like.

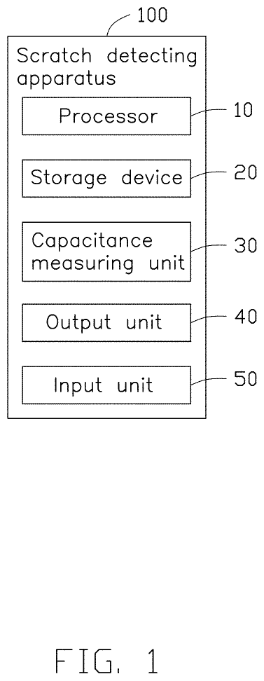

FIG. 1 illustrates a scratch detecting apparatus 100 of an exemplary embodiment of the present disclosure. The scratch detecting apparatus 100 may include a processor 10, a storage device 20, a capacitance measuring unit 30, an output unit 40, and an input unit 50. The storage device 20, the capacitance measuring unit 30, the output unit 40 and the input unit 50 may be electrically connected to the processor 10. The scratch detecting apparatus 100 may be used to detect whether any object, for example a car or an airplane, has been scratched and whether there is surface damage. The scratch detecting apparatus 100 may be, but is not limited to, a device such as a personal computer, a server, or a controller. In one embodiment, the scratch detecting apparatus 100 may be mounted on a control device in the vehicle.

The processor 10 may be composed of integrated circuits. For example, the processor 10 may be composed of a single packaged integrated circuit, or may be composed of multiple integrated circuits of the same function or different functions. The processor 10 may include one or more central processors (Central Processing unit (CPU)), a microprocessor, a digital processing chip, a graphics processor, or a combination of various control chips.

The storage device 20 is used to store various types of data in the scratch detecting apparatus 100, such as program codes and the like.

The storage device 20 may be, but is not limited to, read-only memory (ROM), random-access memory (RAM), erasable programmable ROM (EPROM), electrically EPROM (EEPROM), hard disk, solid state drive, or other forms of electronic, electromagnetic, or optical recording medium.

The capacitance measuring unit 30 is configured to be connected to a surface of the vehicle. The surface of the vehicle is provided with a conductive shield, and the capacitance measuring unit 30 is further configured to measure a capacitance value of the conductive shield in real time.

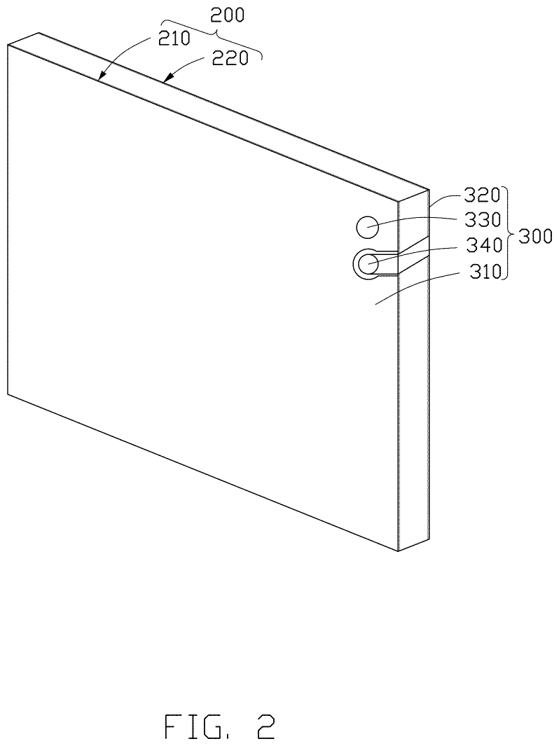

The vehicle may be divided into one or more areas according to the position where scratches are most likely to occur. In one embodiment, the vehicle is a car that may be divided into a plurality of areas such as a front bumper, a rear bumper, a front door, a rear door, and the like. In an alternative embodiment, the vehicle is one area and not divided. FIG. 2 shows an area 200 and a conductive shield 300 arranged on the area 200. The area 200 may include an outer surface 210 and inner surface 220 opposite to the outer surface 210. The conductive shield 300 may include a first conductive film 310 coated on the outer surface 210, and a second conductive film 320 coated on the inner surface 220. The first conductive film 310 and the second conductive film 320 can be transparent or opaque and colored. Since the outer surface 210 and the inner surface 220 are coated by the conductive films, the area 200 constitutes a capacitor structure, and the first conductive film 310 and the second conductive film 320 are two capacitor plates of the capacitor structure. The capacitance measuring unit 30 is connected to the conductive shield 300 and adapted for detecting the capacitance value of the conductive shield 300. Therefore, scratches can be detected by determining whether there is a change in the area or capacitance of the first conductive film 310 in relation to the second conductive film 320.

In at least one embodiment, the conductive shield 300 may further include a first connecting terminal 330 and a second connecting terminal 340. The first connecting terminal 330 is connected to the first conductive film 310 on the outer surface 210. The second connecting terminal 340 is connected to the second conductive film 320 on the inner surface 220. The first connecting terminal 330 and the second connecting terminal 340 are both arranged on the outer surface 210.

The capacitance measuring unit 30 is electrically connected to the first connecting terminal 330 and the second connecting terminal 340 for measuring the capacitance value of the conductive shield 300.

The output unit 40 is configured for outputting information to users, such as outputting results of calculation or processing, audio, text, image, animation, and the like of the scratch detecting apparatus 100. The output unit 40 may be a central control display mounted on the vehicle, or other display devices.

The input unit 50 allows users to input control instructions and the like. In at least one embodiment, the input unit 50 may include, but is not limited to, a mouse, a keyboard, a touch shield, a camera, a remote controller, and the like.

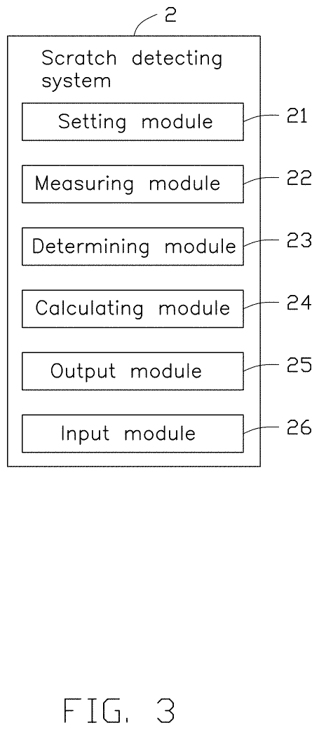

FIG. 3 shows a scratch detecting system 2 running in the scratch detecting apparatus 100. The scratch detecting system 2 may include a plurality of modules, which are a collection of software instructions stored in the storage device 20 and are executed by the processor 10. In the embodiment as disclosed, the scratch detecting system 2 may include a setting module 21, a measuring module 22, a determining module 23, a calculating module 24, an output module 25, and an input module 26.

The setting module 21 is configured to set a reference capacitance value of the conductive shield 300 without scratches or other damages. An allowable error range of the reference capacitance value is also set. The setting module 21 is further configured to receive a reset capacitance value input by the user, and store the reset capacitance value as the reference capacitance value.

In the embodiment as disclosed, the vehicle may include a plurality of conductive shields 300, and each of the conductive shields 300 may be arranged on a corresponding area 200. The setting module 21 can be configured to set a plurality of reference capacitance values corresponding to the plurality of conductive shields 300. The reference capacitance values of the conductive shields 300 and the allowable error ranges of the reference capacitance values can be set by the setting module 21 and stored in the storage device 20.

The setting module 21 is further configured to set a reference area of the conductive shield 300 and level calibration values of the damage.

The measuring module 22 is configured to obtain a real-time capacitance value of the conductive shield 300 measured by the capacitance measuring unit 30.

The determining module 23 is configured to determine whether the real-time capacitance value is within the error range of the preset reference capacitance value.

When there is more than one conductive shield 300, the determining module 23 is configured to determine whether the real-time capacitance value of each conductive shield 300 is within the error range of the corresponding reference capacitance value.

The determining module 23 is further configured to determine the damage level of the conductive shield 300.

The calculating module 24 is configured to calculate an actual area and a damage area of the conductive shield 300, and a ratio of the damage area to the preset reference area. As the capacitance value is related to the area of the first conductive film 310 opposite to the second conductive film 320, the actual area and the damage area of the conductive shield 300 can be calculated by the real-time capacitance values.

The output module 25 is configured to generate a prompt to the output unit 40 to indicate that the vehicle surface has been scratched and damaged. In one embodiment, the output module 25 is configured to generate the prompt to the output unit 40. The output unit 40 displays the area 200 and the damage level at which the scratch is detected, and may also sound an alarm, according to the user's setting.

The input module 26 is configured to receive a reset capacitance value input by a user. In at least one embodiment, the reset capacitance value received by the input module 26 may be a reset capacitance value input by the user through the input unit 50 or other electronic device (not shown).

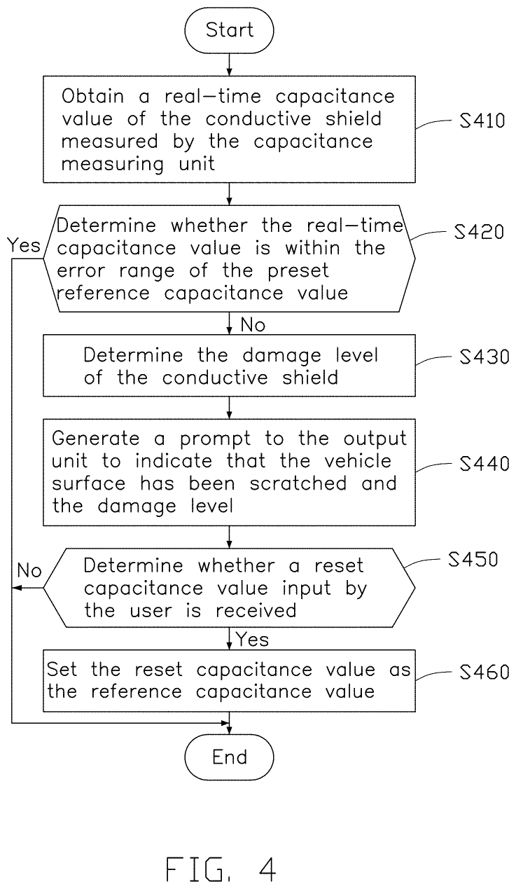

A scratch detecting method is illustrated in FIG. 4. The method is provided by way of embodiments, as there are a variety of ways to carry out the method. Each block shown in FIG. 4 represents one or more processes, methods, or subroutines carried out in the example method. Additionally, the illustrated order of blocks is by example only and the order of the blocks can be changed. The method can begin at block S410.

At block S410, the measuring module obtains a real-time capacitance value of the conductive shield 300 measured by the capacitance measuring unit 30. There may be one or more than one conductive shield 300.

Preferably, the process at block S410 may be activated each time when the vehicle is started, or can be activated according to a schedule.

At block S420, the determining module determines whether the real-time capacitance value is within the error range of a preset reference capacitance value C0. If not, the procedure goes to block S430, otherwise, the procedure is ended.

When the vehicle includes a plurality of conductive shields 300, the reference capacitance values can be plural, and each reference capacitance value is set to correspond to the conductive shield 300. The determining module can determine whether each real-time capacitance value is within the corresponding error range of the preset reference capacitance value.

At block S430, the determining module determines the damage level of the conductive shield 300.

In at least one embodiment, the damage level of the conductive shield 300 can be classified into five categories according to the size of the damage area, these being slight damage, medium damage, partial damage, severe damage, and extra heavy damage. The slight damage is defined when a ratio of the damage area to the reference area is not greater than ⅕. The medium damage is defined when the ratio of the damage area to the reference area is greater than ⅕ but not greater than ⅖. The partial damage is defined when the ratio of the damage area to the reference area is greater than ⅖ but not greater than ⅗. The serious damage is defined when the ratio of the damage area to the reference area is greater than ⅗ but not greater than ⅘. The extra heavy damage is defined when the ratio of the damage area to the reference area is between ⅘ and 1.

In at least one embodiment, the block S430 may include steps as follows.

Firstly, the determining module compares the real-time capacitance value of the conductive shield 300 to preset level calibration values of the damage.

In the preferred embodiment, the level calibration values of the damage can include a first level calibration value C1, a second level calibration value C2, a third level calibration value C3 and a fourth level calibration value C4. The vehicle manufacturer can simulate damage to a sample area. The first level calibration value C1 is the capacitance value of the sample area when the ratio of the damage area to the reference area is ⅕ in the simulation. The second level calibration value C2 is the capacitance value of the sample area when the ratio of the damage area to the reference area is ⅖ in the simulation. The third level calibration value C3 is the capacitance value of the sample area when the ratio of the damage area to the reference area is ⅗ in the simulation. The fourth level calibration value C4 is the capacitance value of the sample area when the ratio of the damage area to the reference area is ⅘ in the simulation. The level calibration values C1, C2, C3, C4, and the reference capacitance value C0 can be set before the vehicle leaves the vehicle manufacturer and stored in the storage device 20.

Secondly, the determining module determines the damage level of the conductive shield 300.

When the real-time capacitance value of the conductive shield 300 is less than the reference capacitance value C0 and not less than the first level calibration value C1, the determining module determines that the damage level of the conductive shield 300 is slight damage. When the real-time capacitance value of the conductive shield 300 is less than the first level calibration value C1 and not less than the second level calibration value C2, the determining module determines that the damage level of the conductive shield 300 is medium damage. When the real-time capacitance value of the conductive shield 300 is less than the second level calibration value C2 and not less than the third level calibration value C3, the determining module determines that the damage level of the conductive shield 300 is partial damage. When the real-time capacitance value of the conductive shield 300 is less than the third level calibration value C3 and not less than the fourth level calibration value C4, the determining module determines that the damage level of the conductive shield 300 is severe damage. When the real-time capacitance value of the conductive shield 300 is less than the fourth level calibration value C4 and not less than zero, the determining module determines that the damage level of the conductive shield 300 is extra heavy damage. When the real-time capacitance value of the conductive shield 300 is zero, the determining module determines that the conductive shield 300 is totally destroyed or lost or that the scratch detecting system 2 is destroyed.

In an alternative embodiment, the block S430 may include steps as follows.

Firstly, an actual area S1 of the conductive shield 300 is calculated based on the real-time capacitance value.

According to the formula C=εS/4πkd, formula S=4Cπkd/ε can be obtained. C is the capacitance value, n=3.14, k is the electrostatic force constant and k=9.0×10\hat{ }9, d is a distance of the capacitor plates, c is a constant depending on the material itself, and S is the area of the capacitor plates opposing each other.

Therefore, the calculating module calculates the actual area S1 of the conductive shield 300 by the formula S=4Cπkd/ε, and the actual area S1 is equal to the area of the first conductive film 310 facing the second conductive film 320.

Secondly, a damage area S2 is calculated based on the actual area S1 and a preset reference area S0.

The calculating module calculates the damage area S2 by applying the formula S2=S0−S1.

The capacitance value of the conductive shield 300 can be measured before the vehicle leaves the vehicle manufacturer. The reference area S0 of the conductive shield 300 can be calculated by the formula S=4Cπkd/ε, and stored in the storage device 20.

Thirdly, a ratio of the damage area S2 to the reference area S0 is calculated, and the damage level of the conductive shield 300 is determined.

The calculating module calculates the ratio of the damage area S2 to the reference area S0, and the determining module determines the damage level of the conductive shield 300 based on the ratio of the damage area S2 to the reference area S0.

When the ratio of the damage area S2 to the reference area S0 is greater than zero and not greater than ⅕, the determining module determines that the damage level of the conductive shield 300 is slight damage. When the ratio of the damage area S2 to the reference area S0 is greater than ⅕ and not greater than ⅖, the determining module determines that the damage level of the conductive shield 300 is medium damage. When the ratio of the damage area S2 to the reference area S0 is greater than ⅖ and not greater than ⅗, the determining module determines that the damage level of the conductive shield 300 is partial damage. When the ratio of the damage area S2 to the reference area S0 is greater than ⅗ and not greater than ⅘, the determining module determines that the damage level of the conductive shield 300 is severe damage. When the ratio of the damage area S2 to the reference area S0 is greater than ⅘ and not greater than 1, the determining module determines that the damage level of the conductive shield 300 is extra heavy damage. When the ratio of the damage area S2 to the reference area S0 is equal to 1, the determining module determines that the damage level of the conductive shield 300 is total destruction.

In other embodiments, the damage level of the conductive shield 300 may be classified into two, three, four, or more than five categories.

At block S440, a prompt is generated to the output unit 40 to indicate that the vehicle surface has been scratched.

The output module can generate the prompt to the output unit 40 to indicate that the vehicle surface has been scratched. The output unit 40 may display the area 200 which has been scratched, or issue an alarm sound according to the use's settings.

At block S450, the input module 26 determines whether a reset capacitance value input by the user is received.

If the user does not need to repair of the damaged surface immediately, the user can input the reset capacitance value through the input unit 50 or other electronic device, in order to prevent the scratch detecting system 2 from repeating the alarm when the vehicle is started next time. The input module 26 determines if a reset capacitance value input by the user is received. If YES, the process proceeds to block S460, otherwise, the process ends.

At block S460, the reset capacitance value is set as the reference capacitance value.

Specifically, the setting module 21 sets the reset capacitance value input by the user as the reference capacitance value, and stores it in the storage device 20. When the scratch detecting system 2 is activated next time, the updated reference capacitance value is used for detecting scratches.

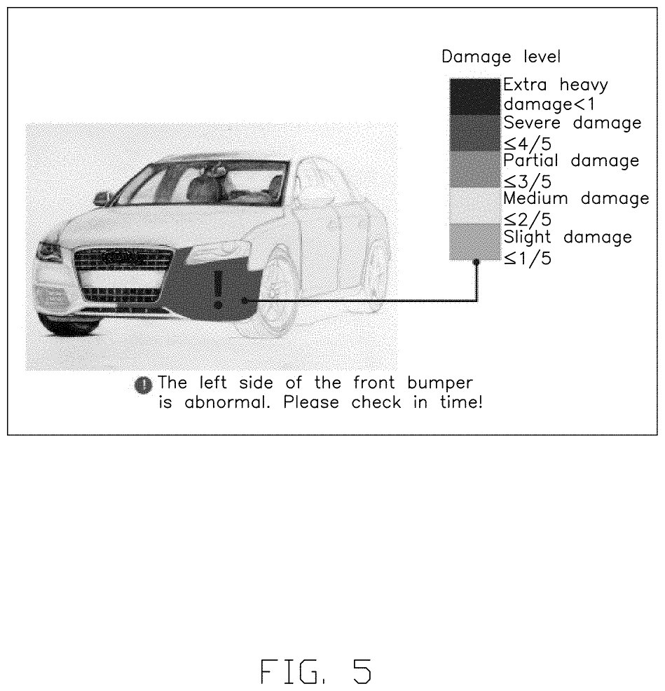

FIG. 5 shows a schematic diagram of a display interface on the output unit 40 according to an embodiment. After the output unit 40 receives the prompt, the output unit 40 displays the prompt in the display interface. The display interface can display a diagram or outline of the vehicle and indicate the area where the scratch occurred and the damage level. Different damage levels can be represented by different colors, and each area of the vehicle is displayed in a color corresponding to the damage level.

In the embodiment, the vehicle is a car and may be divided into areas including a left side of the front bumper, a right side of the front bumper, a hood, a left front door, a left rear door, a right front door, and a right rear door. Each of the areas 200 is provided with one conductive shield 300. When the scratch detecting system 2 detects that the left side of the front bumper has been scratched and the damage level is serious, the display of the output unit 40 displays a diagram of the vehicle, and prompts “The left side of the front bumper is abnormal. Please check in time!”. Therefore, the user can check for scratches in time by viewing the display interface.

In other embodiments, the display interface of the output unit 40 may also include only text prompts or graphic prompts.

In other embodiments, the process in block S430 may be canceled. The prompt generated by the output module 25 in block S440 can indicate one or more areas 200 that have been scratched, but does not indicate the damage level.

In other embodiments, the processes in block S450 and S460 may be canceled if the user does not need to reset the capacitance reference value.

In other embodiments, the first connecting terminal 330 and the second connecting terminal 340 can be arranged on the inner surface 220.

In other embodiments, the first connecting terminal 330 and the second connecting terminal 340 can be canceled, as long as the capacitance measuring unit 30 can contact the first conductive film 310 and the second conductive film 320.

In the exemplary embodiment, the conductive shield 300 is adapted for connecting to the capacitance measuring unit 30 for measuring a capacitance. Detecting that a vehicle has been scratched is a matter of determining whether there is a change in an area of the first conductive film opposite to the second conductive film. The conductive shield 300 is easy to implement and low in cost. The size of the conductive shield 300 can be set according to the position of the vehicle to be monitored. After the conductive shield 300 is damaged, repair of the conductive shield can be done by re-spraying for example, and the operation is simple.

The scratch detecting apparatus 100 and the scratch detecting method may determine whether the real-time capacitance value is within the error range of a preset reference capacitance value by obtaining the real-time capacitance value measured by the capacitance measuring unit, determine whether the vehicle has been scratched, and generate a prompt that the vehicle had been scratched or rubbed against. Therefore, the scratch detecting apparatus 100 and the scratch detecting method can detect whether the vehicle has been scratched, and monitor whether the vehicle has surface damage in real time, so that the user can view the result in time.

A person skilled in the art can understand that all or part of the process in the above embodiments can be implemented by a computer program to instruct related hardware, and that the program can be stored in a computer readable storage medium. When the program is executed, a flow of an embodiment of the methods as described above may be included.

In addition, each functional unit in each embodiment of the present invention may be integrated in one processor, or each unit may exist physically separately, or two or more units may be integrated in one same unit. The above integrated unit can be implemented in the form of hardware or in the form of hardware plus software function modules.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A conductive shield adapted for detecting scratches of a vehicle, the conductive shield comprising:
a first conductive film coated on an outer surface of the vehicle; and
a second conducive film coated on an inner surface of the vehicle;
wherein the conductive shield is connected to a capacitance measuring unit adapted for measuring a capacitance, and scratches on the vehicle are detected by determining whether there is a change in an area of the first conductive film opposite to the second conductive film.

2. The conductive shield of claim 1, wherein the conductive shield further comprises a first connecting terminal and a second connecting terminal, the first connecting terminal is connected to the first conductive film, the second connecting terminal is connected to the second conductive film, and each of the first connecting terminal and the second connecting terminal is electrically connected to the capacitance measuring unit.

3. The conductive shield of claim 2, wherein the first connecting terminal and the second connecting terminal are arranged on the outer surface of the vehicle.

4. A scratch detecting apparatus configured to detect whether a vehicle has been scratched, a surface of a vehicle coated by a conductive shield, the scratch detecting apparatus comprising:
a capacitance measuring unit connecting to the conductive shield of the vehicle and configured for measuring a capacitance value of the conductive shield in real-time;
an output unit;
a processor; and
a storage device storing one or more programs, when executed by the processor, the one or more programs causing the processor to:
obtain the real-time capacitance value of the conductive shield measured by the capacitance measuring unit;
determine whether the real-time capacitance value is within an error range of a preset reference capacitance value; and
generate a prompt to the output unit to indicate that the vehicle surface has been scratched when the real-time capacitance value is not within the error range of the preset reference capacitance value.

5. The scratch detecting apparatus of claim 4, wherein the one or more programs further cause the processor to determine a damage level of the conductive shield when the real-time capacitance value is not within the error range of the preset reference capacitance value, and the prompt further comprises the damage level of the conductive shield.

6. The scratch detecting apparatus of claim 5, wherein in a process of determining the damage level of the conductive shield, the one or more programs further cause the processor to compare the real-time capacitance value to preset level calibration values of the damage.

7. The scratch detecting apparatus of claim 5, wherein a process of determining the damage level of the conductive shield comprises the steps of:
calculate an actual area of the conductive shield based on the real-time capacitance value;
calculate a damage area based on the actual area and a preset reference area; and
calculate a ratio of the damage area to the reference area, and determine the damage level of the conductive shield.

8. The scratch detecting apparatus of claim 4, wherein after generating the prompt to the output unit, the one or more programs further cause the processor to:
determine whether a reset capacitance value input is received;
set the reset capacitance value as the reference capacitance value after the reset capacitance value is received.

9. The scratch detecting apparatus of claim 4, wherein the number of the conductive shields is plural, the number of the reference capacitance values is plural and each of the reference capacitance values is set to correspond to each of the conductive shields, and the error range of the preset reference capacitance value is stored in the storage device.

10. A scratch detecting method configured to detect whether a vehicle has been scratched, comprising:
obtaining a real-time capacitance value of a conductive shield measured by a capacitance measuring unit;
determining whether the real-time capacitance value is within an error range of a preset reference capacitance value; and
generating a prompt to an output unit to indicate that a surface of the vehicle has been scratched when the real-time capacitance value is not within the error range of the preset reference capacitance value.

11. The scratch detecting method of claim 10, wherein scratch detecting method further comprises determining a damage level of the conductive shield when the real-time capacitance value is not within the error range of the preset reference capacitance value; and the prompt further comprises the damage level of the conductive shield.

12. The scratch detecting method of claim 11, wherein in a process of determining the damage level of the conductive shield, the real-time capacitance value is compared to preset level calibration values of the damage.

13. The scratch detecting method of claim 11, wherein a process of determining the damage level of the conductive shield comprises the steps of:
calculate an actual area of the conductive shield based on the real-time capacitance value;
calculate a damage area based on the actual area and a preset reference area; and
calculate a ratio of the damage area to the reference area, and determine the damage level of the conductive shield.

14. The scratch detecting method of claim 10, wherein after generating the prompt to the output unit, the scratch detecting method further comprises:
determining whether a reset capacitance value input is received;
setting the reset capacitance value as the reference capacitance value after the reset capacitance value is received.

15. The scratch detecting method of claim 10, wherein the number of the conductive shields is plural, the number of the reference capacitance values is plural and each of the reference capacitance values is set to correspond to each of the conductive shields, and the error range of the preset reference capacitance value is stored in a storage device.
